(19) United States
(12) Patent Application Publication
(10) Pub. No.: US 2003/0032327 A1
(43) Pub. Date: Feb. 13, 2003

(54) Filler unit for a control device of a vehicle

(76) Inventor: John A. LaBonte, Rice Lake, WI (US)

Correspondence Address: GOTTLIEB RACKMAN & REISMAN PC, 270 MADISON AVENUE, 8TH FLOOR, NEW YORK, NY, 100160601

(21) Appl. No.: 10/214,922

(22) Filed: Aug. 7, 2002

Related U.S. Application Data
(60) Provisional application No. 60/310,728, filed on Aug. 8, 2001.

(51) Int. Cl. H01R 13/60

(52) U.S. Cl. 439/527; 361/600

(57) ABSTRACT

A filler unit for carrying a device, for example to actuate toggle switches, for controlling lighting and audio accessories of a vehicle, such as motorcycles, all-terrain vehicles and the like, which comprises a master cylinder normally mounted on a wheel-steering member, such as handlebars. The master cylinder, while performing its normal functions as a brake control, has a support casing affixed to the wheel-steering member in close proximity to an operator's hand. The filler unit's housing is positioned on the master cylinder support casing in vertical alignment therewith, thereby resulting in an integrated “sandwich” structure. The switches of the control device are located on the front portion of the housing for convenient operation, thereby achieving a compact and readily accessible configuration, which is also cosmetically compatible with the streamlined look of the vehicle.

### RELATED APPLICATIONS

This application claims priority to a provisional patent application Serial No. 60/310,728, filed Aug. 8, 2001.

### FIELD OF THE INVENTION

The present invention relates generally to a filler unit for carrying an actuating device, for example toggle switches, for controlling lighting and audio accessories of a vehicle, such as motorcycles, all-terrain vehicles and the like, and which comprises a master cylinder with which the filler unit can be integrally mounted as part of the wheel-steering member.

### DESCRIPTION OF THE PRIOR ART

Despite the present abundance and wide variety of vehicle model and types, the problem of a convenient accessory switches, compatible with a variety of vehicle designs, and reliable in operation structure for mounting the actuating device for such switches is increasing demand. The structures that have been currently employed to achieve convenient operation of vehicle switching devices suffer from the following major deficiency, common to all of them: they all mounted on the vehicle as afterthoughts, and thus not convenient in operation, and are not easily coordinated with the vehicle's structure.

More specifically, one of the known market solution approaches is an oversized box that can hold several switches that slides over the master cylinder itself, which is commonly located on a motorcycle's handlebar. While this solution is somewhat convenient, it is larger than needed, thus making checking the brake fluid level in the master cylinder more difficult. It is also too tall and can interfere with the windshield visibility when fully turning the handlebars on some bikes, posing a safety concern. This solution is not also easily adaptable from model to model, and requires alterations even if the master cylinder is the same size, as mounting clamps vary from model to model, as do mirrors and other assemblies that intefere with the device (see Custom Chrome Catalog, Custom Chrome, Incorporated, 16100 Jacqueline Court, Morgan Hill, Ca, 2000, page 7.50).

Another prior art solution is a switch holder assembly that can mount directly on the handlebar. These devices usually only accommodate a maximum of 2 switches and are mounted quite inconveniently. Due to mounting on the rider side of the handlebars, the wiring is exposed for several inches before it can be routed with other wires to the “fork” area, where it can be protected and hidden. This part is also not easily adaptable from bike to bike due to handlebar size, style, location and mounting of grips and control boxes (see Parts Unlimited Touring Catalog, LeMans Corporation, 3501 Kennedy Road, Janesville, Wis., 2001, page 44).

One of the most widely used methods that has heretofore been used to solve this problem is by providing an extra or separate switch element as an accessory to be sold separately, and letting the consumer try to determine where to mount the switch to control that new accessory device. This usually results in mounting the switch on the side of the motorcycle in a battery cover or other fairing piece by drilling a hole in the fairing attachments or related structure. This generally causes a big safety concern, as such random locations are often not convenient or easily reached, requiring the rider to fumble for the switch which takes his eyes off his driving (see Drag Specialities Fat Book Catalog, LeMans Corporation, 3501 Kennedy Road, Janesville, Wis., 2001, page 476).

The remaining choice before now has been to wire any accessory function directly into the ignition system to allow the lighting to automatically come on when the key is turned or high beams are switched on. While this results in total rider safety, it increases the starting loads on the bike's battery, and eliminates any choice of the rider to switch on or off, especially during the daylight hours when all the lighting may not be needed and the inability to switch it off could be a distraction to other drivers (see Custom Chrome Catalog, Custom Chrome, Incorporated, 16100 Jacqueline Court, Morgan Hill, Ca, 2000, page 7.59).

Further examples of known prior art are disclosed in U.S. Pat. No. 6,225,584 issued on May 1, 2001 to Honda Giken Kogyo Kabushiki Kaisha and U.S. Pat. No. 4,437,091 issued on Mar. 13, 1984 to Nissin Kogyo Co., Ltd.

### SUMMARY OF THE INVENTION

It is therefore a primary object of the invention to provide a filler unit that allows mounting of a controlling device in a manner that is convenient, compact, readily accessible by the operator of the vehicle, and is compatible with an appearance of the various vehicle models.

It is another object of this invention to provide an integral array of switches for the operator of a vehicle that will assist in the pleasurable operation of the vehicle and yet improve the safety factor associated with the functions achieved by such switches.

It is still another object of this invention to provide for accessory switches that are either needed or desirable in the operation of a vehicle, particularly a motorcycle, to be built into existing and necessary structure of the vehicle without detracting from the appearance thereof.

It is a further object of this invention to enhance the utility of a motor vehicle in a manner consistent with the desires of the operating public already familiar with such vehicles, thereby allowing the promotion of convenience, safety and aesthetic characteristics.

With a view to attaining this and other objects, the proposed invention is constructed in the following manner. The filler unit for carrying a control device includes a housing which is positioned on the master cylinder support casing and vertically aligned therewith, while the support casing itself is affixed to a wheel-steering member of the vehicle in close proximity to an operator's hand. The control device is mounted on a front portion of the surrounding wall of the housing. The housing of the filler unit and the supporting casing of the master cylinder are shaped in congruent fashion, so as to form an integral “sandwich” structure. The filler unit has an inner cavity with conductors disposed therein for interconnecting the control device with accessory's wiring. The inner cavity is open at the top and is provided with a cover for weather protection for the conductors. The existing master cylinder cover may serve as the filler unit housing cover, while a solid bottom surface of the housing acts as a cover of the master cylinder casing.

The construction of the filler unit for a control device in accordance with the present invention will become more apparent and understandable from the following detailed description thereof, when read in conjunction with the accompanying drawings.

### BRIEF DESCRIPTION OF THE ACCOMPANYING DRAWINGS

FIG. 1 is a perspective view of a portion of the vehicle from the operator's viewpoint, with the filler unit mounted on the master cylinder support casing affixed to the wheel-steering member of the vehicle;

FIG. 2 is an enlarged perspective view of the assembled filler unit shown mounted on a fragmentary portion of a vehicle's handlebar;

FIG. 3 is an exploded view of the filler unit, showing the constituent parts thereof, including a cover, the control device positioned on the housing surrounding wall and the master cylinder support casing;

FIG. 4 is a sectional view of the filler unit taken along the line 4-4 of FIG. 2 in the directions of the arrows;

FIG. 5 is a sectional view of the filler unit taken along the line 5-5 of FIG. 2 in the direction of the arrows;

FIG. 6 is a top view of the filler unit showing the inner cavity of the housing with the a plurality of conductors disposed therein;

FIG. 7 is a bottom view of the filler unit;

FIG. 8 is a rear view of the filler unit, with the wires extended therefrom;

FIG. 9 is a front view of the filler unit, with the control devices situated on a front portion of the housing wall;

FIG. 10 is a left side view of the filler unit; and

FIG. 11 is right side view of the filler unit.

### DETAILED DESCRIPTION OF THE PREFERRED EMBODIMENT

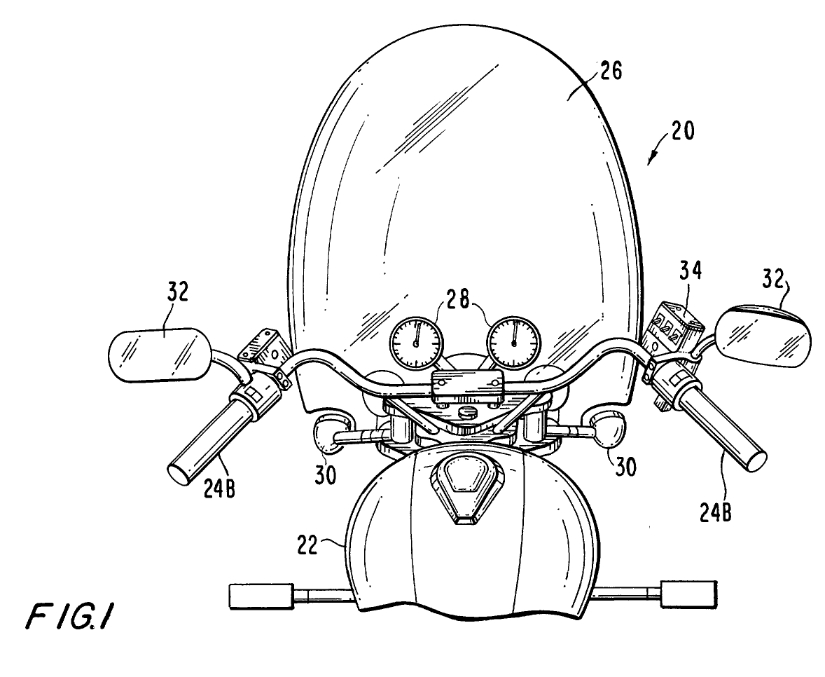

Turning now to the drawings, FIG. 1 shows a partial view of the vehicle, such as a motorcycle 20, incorporating a filler unit according to the invention. The filler unit, as described below, can be employed for carrying a control device for actuating lighting and audio accessories of various types for vehicle 20.

In further considering the illustration of FIG. 1, it will be appreciated that motorcycle 20 is shown in partial or fragmentary form from the rider's perspective, facing forward. In that view, the main body or chassis 22 is shown broken away, with appropriate conventional gauges (not separately numbered) mounted thereon. Forward of the chassis member (which is generally spherical or elliptical in shape) are the left and right handlebars 24A and 24B, respectively, a windshield 26, typical gauges 28, left and right directional lights 30, left and right side view mirrors 32 and, focusing on the present invention, a filler unit 34 to be described in greater detail hereinafter.

As in most motorcycles of this type, the operator maneuvers the vehicle by steering the handlebars 24A and 24B on which both hands are usually placed, while he is simultaneously looking through the windshield at the view in front of the driver and examining the left and right sides and rear of the vehicle through the side view mirrors 32. All of this time, the driver is necessarily occupied with these vistas and is also concerned, at times, with operating various electrical devices through the vehicle, particularly lights and occasionally audio devices. These are frequently activated by switches directly associated with the device to be energized and have often been inconveniently located or dispersed from each other such that many physical functions are required before the devices can be activated, often diverting the operator's from the important driving functions.

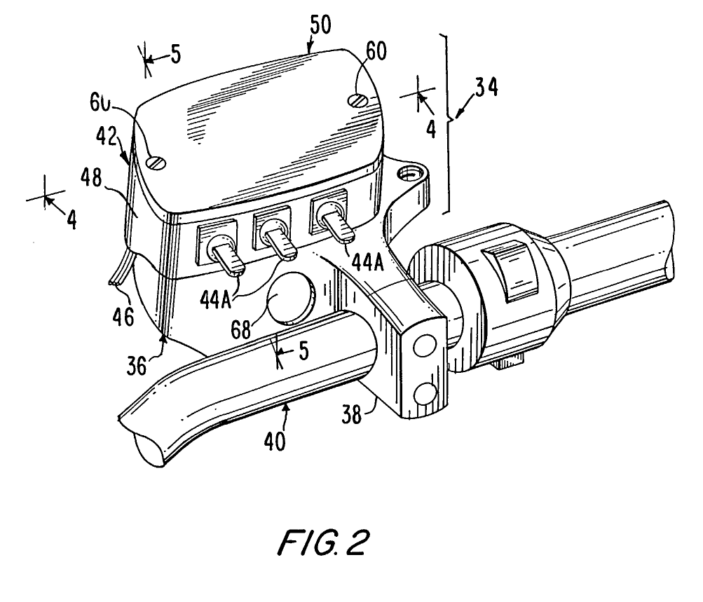

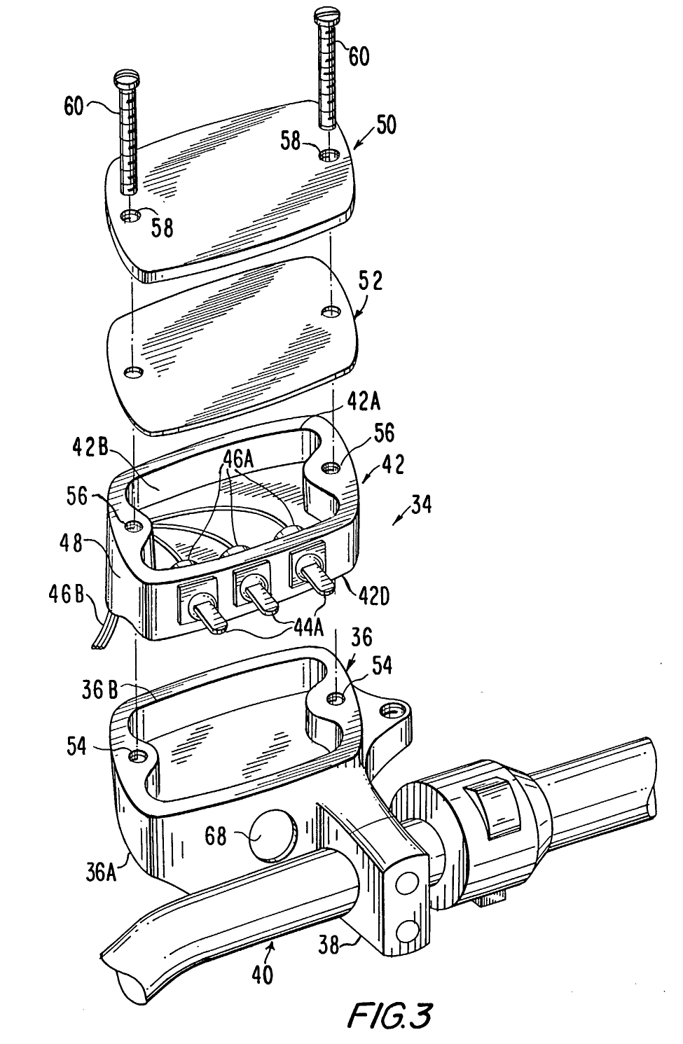

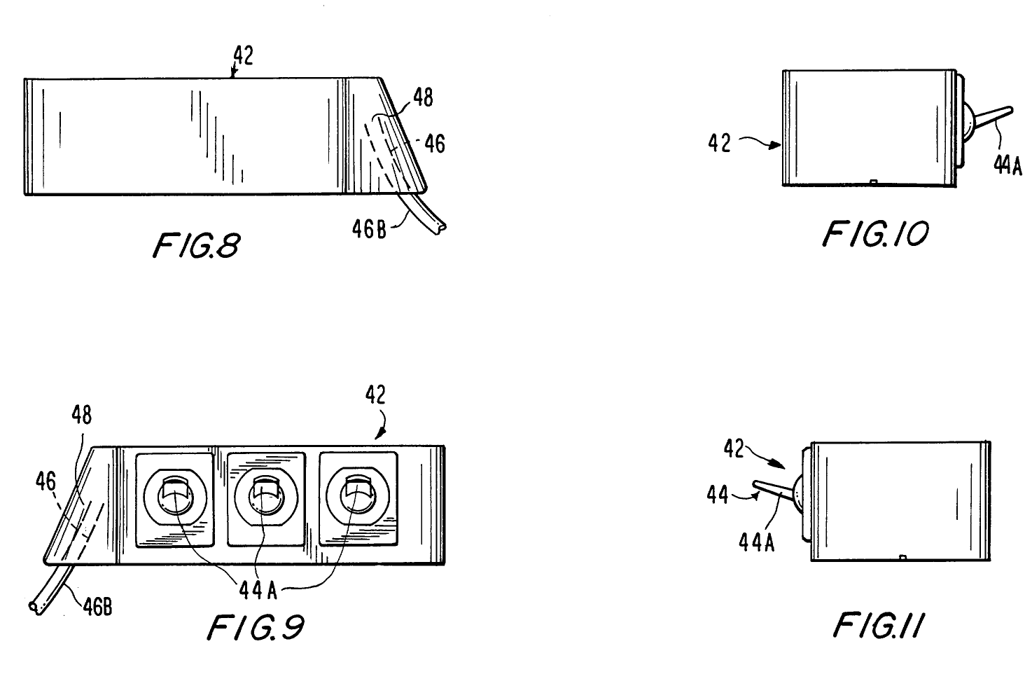

In this particular invention, the coordination of the master cylinder with the filler unit 34 achieves many goals that the prior art has overlooked or been unable to overcome. In particular, the vehicle 20, for example a motorcycle, includes a master cylinder for providing brake control in a conventional manner. In its assembled form as shown in FIG. 2, the filler unit of this invention, identified as 34, is shown mounted by an appropriate and conventional bracket 38 on the handlebar structure 40. The master cylinder 36 has a support portion 36A (see FIG. 3) through which an aperture (not shown) provides a glass window 68 for visual access into the reservoir for the brake fluid, thus allowing a vehicle operator to know at all times whether the brake fluid is at the proper level. Normally, the master cylinder housing is topped by a screwed-down cover plate 50, but the present invention takes advantage of that arrangement by removing the cover plate 50 and allowing the filler unit 34 to be “sandwiched” between the master cylinder's support housing 36A and the cover plate 50. Also as shown in FIG. 2, the central housing 42 for the filler unit presents, on the driver's side, three toggle switches 44A which are illustrative of the types of control that the driver needs to have over various electrical or audio functions (not shown) which have heretofore been placed in many different locations throughout the vehicle and therefore have been inconvenient to operate while the vehicle is in motion. (These functions are controlled by the conductors 46 shown in fragmentary form emerging from the left side of the housing 42 of the filler unit 34. In order to get a more complete understanding of how the invention operates, references should be made to FIGS. 3-11, which will give greater insight into the physical and structural make-up of the invention's components.)

As shown in the exploded view of FIG. 3, the master cylinder has a support casing 36A, which is affixed to a wheel-steering member, such as a handle-bar assembly 40 in a close proximity to a driver's hand (not shown). The support casing 36A includes an inner cavity defined at 36B and is provided with two threaded screw-holes 54 for subsequent assembly to the superimposed parts to be described below. The covered window 68 is located on the support casing 36A for visual measurement of the brake fluid, as shown in FIGS. 2 and 3.

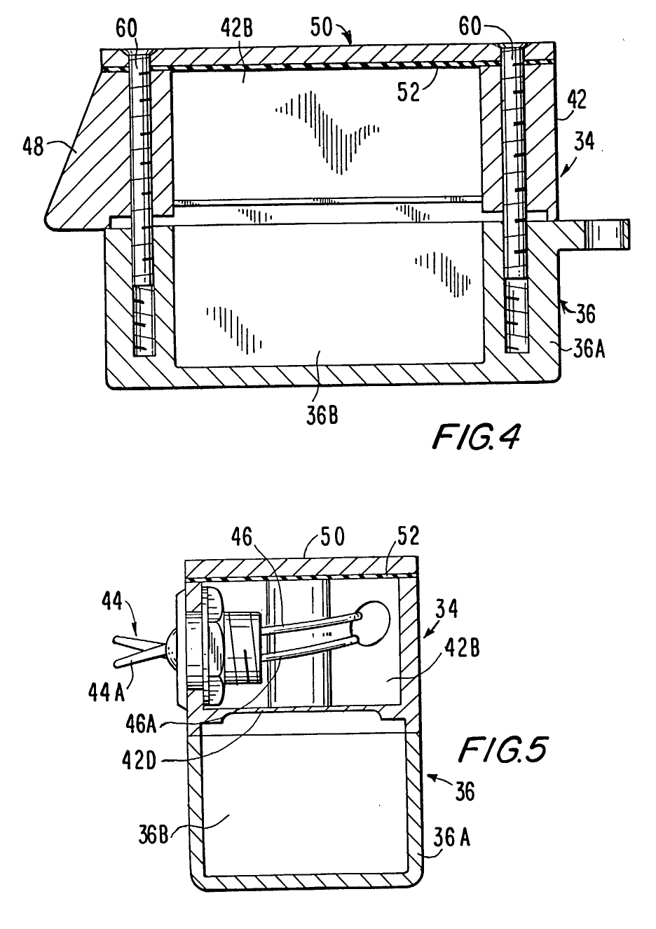

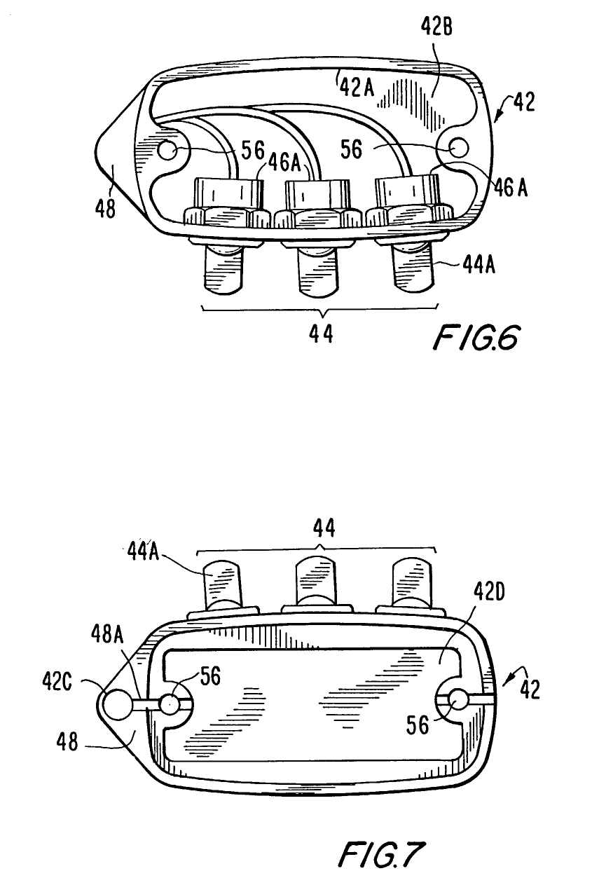

The support casing 36A serves as a base for the filler unit housing 42. The housing 42 is designed to conform to the outline shape of the master cylinder support casing 36A and is congruently aligned therewith, as can be viewed from FIGS. 2 and 4. The housing 42 also has a surrounding wall 42A which is of sufficient thickness to carry a control device 44 on a its front portion. The control device 44 includes, for example, a plurality of toggle switches 44A for actuating lighting and audio accessories of the motorcycle, as shown in FIGS. 6, 7, 9, 10 and 11. It is understood that dimensions of the surrounding wall 42A, such as their diameter and thickness, could be adapted to any measurements that are deemed to be suitable for the particular type of the vehicle master cylinder to which this invention is being applied.

The surrounding housing wall 42A forms an inner cavity 42B within the filler unit housing 42 for the positioning of conductors, such as wires 46. The inner cavity 42B is virtually identical in configuration to inner cavity 36B of the master cylinder support casing 36A.

Each of the wires 46 has one end 46A connected to the rear of the respective toggle switches 44A, and its other end 46B coupled to the selected wiring of the vehicle appliances, such as lighting and audio accessories (not shown). The bundled wires ends 46B emerge from the inner cavity 42B through the downwardly extending hollow channel 48A (see FIG. 7) formed within an outwardly protruding flange 48 configured on the surrounding wall 42A, and then through external hole 42C, after aligning the housing 42 with the underlying support casing 36A (see also FIGS. 4, 8 and 9).

The filler unit housing 42 has an opening at its top to allow easy access to the wiring 46 located in the inner cavity 42B. The cover 50 is congruently positioned on the upper surface of the surrounding wall 42A for weather and dust protection; similarly, underlying gasket element 52 is placed beneath cover 50. It should be noted that the existing master cylinder cover can act as the cover 50, and that the conventional cover is merely removed from the support casing 36A to allow the filler unit housing 42 to be positioned between there. It is understood that such conventional cover can be replaced with a cover specially designed for a particular type of vehicle and in accordance with a consumer's preference.

The solid bottom surface 42D of the housing conveniently serves as a protective cover for the inner cavity 36B of the master cylinder. The surrounding inner wall 42A of the filler unit housing 42 and the cover 50 (as well as gasket 52) are each provided with two axially aligned threaded holes 56 and 58, respectively, of substantially the same size as the similarly aligned holes 54 of the master cylinder.

To assemble the filler unit 34 onto a master cylinder 36, the holes of the filler unit housing, its cover and of the master cylinder support casing are aligned with each other. Two bolts 60, each of which has a length substantially equal to the total length of the aligned holes, are inserted through the holes and are then tightened at the respective sides of the assembled parts, so as to form an integral “sandwich” structure. The fully assembled invention is shown in FIG. 2.

Now that the invention has been described in detailed terms, it will be appreciated that an operator can continue riding along the road in the normal fashion, and with the usual pressures of driving that require concentration in many areas, and yet conveniently manipulate the toggle switches 44A that form a part of the vehicle filler block 34, and operate them selectively as needed after having installed the device in conjunction and coordination with master cylinder 36. In so doing, the prior art's notorious problems of inconvenience and lack of safety in operating many of the accessory switches often located at disparate locations throughout the vehicle have been avoided. And yet the ease of checking the brake fluid in the master cylinder through the normal window glass at 68 has been maintained with no change in the operator's usual perception of that function. This combination of features and functions allows the operator to operate a safe vehicle, maintaining vigilance on the road and yet having the complete capacity to control all of the electrical and audio functions (as well as any other functions that may arise), with complete mastery and no difficulties.

Although, the foregoing description of this invention has been presented in connection with the preferred embodiment thereof, it will be appreciated by those skilled in the art that some substitution and/or additions may be made without departing from the spirit and scope of the invention as defined in the appended claims.

What is claimed:

1. A filler unit for a control device of a vehicle that comprises a master cylinder and a wheel-steering member, said master cylinder having a support casing affixed to said wheel-steering member in close proximity to an operator's hand, said filler unit including a housing positioned on said master cylinder casing and vertically aligned therewith, said housing having a surrounding wall to carry said control unit on a front portion thereof for ready actuation by said operator.

2. A filler unit for a control device of a vehicle according to claim 1, wherein said housing of said filler unit and said support casing of said master cylinder are substantially congruent with each other.

3. A filler unit for a control device of a vehicle according to claim 1, wherein said filler unit further comprises a cover removably mounted on an upper edge of said surrounding wall of said filler unit housing.

4. A filler unit for a control device of a vehicle according to claim 3, wherein said cover is a cover of said master cylinder casing.

5. A filler unit for a control device of a vehicle according to claim 3, said filler unit including a sealing element conforming to the outer dimensions of said cover and interposed between said cover and said casing.

6. A filler unit for a control device of a vehicle according to claim 3, wherein said sealing element is a gasket.

7. A filler unit for a control device of a vehicle according to claim 1, including at least one actuatable element therein, wherein said surrounding wall forms an inner cavity within said filler unit housing, and a plurality of conductors being disposed therein for interconnecting said control unit with said actuatable element.

8. A filler unit for a control device of a vehicle according to claim 7, wherein each said conductor has a first end and a second end, the first end being connected to said control device and said second end being connected to said actuatable element.

9. A filler unit for a control device of a vehicle according to claim 7, wherein said surrounding wall is configured to include an outwardly protruding curved flange defining a downwardly extending hollow channel therein to allow said second end of each said conductor to emerge from the inner cavity of said filler unit housing when the latter is aligned with said master cylinder support casing, for effecting subsequent coupling with actuatable element for actuating and de-actuating of said element in response to said operator's command.

10. A filler unit for a control device of a vehicle according to claim 1, said filler unit further comprising an aligning means, said means including at least one through-hole formed on each side portion of said surrounding wall of said filler unit housing, a wall of said support casing of said master cylinder and said cover of said filler block, respectively, said through-holes being substantially of the same diameter and coaxially aligned with each other at corresponding side portions, said means further comprising at least two fastener elements corresponding to said aligned through-holes and dimensioned to be fixedly interposed within said holes and substantially along their total length.

11. A filler unit for a control device of a vehicle according to claim 10, wherein said through-holes are threaded and said fastener elements are correspondingly threaded to be accommodated in said through-holes.

12. A filler unit for a control device of a vehicle according to claim 1, wherein said control device includes a plurality of toggle switches for actuating and de-actuating selective appliances of said vehicle.

13. A filler unit for a control device of a vehicle according to claim 12, wherein said selective appliances include lighting and audio accessories.
